(19) United States
(12) Patent Application Publication
(10) Pub. No.: US 2013/0342684 A1
(43) Pub. Date: Dec. 26, 2013

(54) Method and System for Determining Particle Size Information

(71) Applicants: Heimo Keranen, Oulu (FI); Matti-Antero Okkonen, Oulu (FI)

(72) Inventors: Heimo Keranen, Oulu (FI); Matti-Antero Okkonen, Oulu (FI)

(73) Assignee: TEKNOLOGIAN TUTKIMUSKESKUS VTT, VTT (FI)

(21) Appl. No.: 13/979,852

(22) PCT Filed: Jan. 13, 2012
(86) PCT No.: PCT/FI2012/050029

§ 371 Date: Sep. 9, 2013

Related U.S. Application Data
(60) Provisional application No. 61/433,982, filed on Jan. 19, 2011.

(51) Int. Cl. G01N 15/02

(52) U.S. Cl. CPC G01N 15/0205; G01N 15/0227
USPC 348/135; 356/335

(57) ABSTRACT

The invention concerns a method and system for determining particle size information of particles contained in a sample, the method comprising illuminating the particles with at least three light sources placed on different locations, detecting light reflected from the particles using a detector capable of spatial resolution, and processing the output of the detector so as to determine the particle size information. According to the invention, the particles are illuminated simultaneously with the at least three light sources each operating at a different wavelength channel, and the wavelength channels are simultaneously detected at the detector. The invention reduces the need for sample preparation, among other benefits.

### FIELD OF THE INVENTION

The present innovation relates to a method of determining particle size information of particles, in particular moving particles, such as pharmaceutical particles.

### BACKGROUND OF THE INVENTION

U.S. Pat. No. 7,733,485 discloses a method for measuring the size and shape of powdery and grain like particles. The method requires sample preparation for leveling the measured particle surface and taking at least two pictures, which excludes the method from measuring moving particles. In the method at least two images of the surface of the sample are taken under illuminations from two light sources placed symmetrically on each side of the sample, the surface structure of the sample remaining at least essentially unchanged in the different measurements. Thus, the method is not suitable for measuring moving particles. In the method described in U.S. Pat. No. 7,733,485 the distance of the measurement head to the particles is made constant by using a transparent glass plate on which the particles are supported.

Other disclosed methods for particle size measurement, such as that disclosed in US 20040151360, typically need special sample preparation. This clearly excludes them from measuring moving particles. Other methods use indirect measurement, where a feature is measured which is only related to particle size. Such methods are disclosed in U.S. Pat. No. 5,870,190 and U.S. Pat. No. 7,420,360. This requires learning of the relation, which can be laborious and valid only for particles and materials that are used for creating the relation.

### SUMMARY OF THE INVENTION

It is an aim of the invention to provide a particle size measurement method and system which is suitable not only for stationary but also for moving particles and does not involve any sample preparation.

A further aim is to accomplish a method and system for particle size measurement without the need to have a transparent glass plate on which the particles are supported. The invention is based on the idea of capturing images of the particles by combining three or more different illumination geometries to the color channels of the image. Further, the images are processed.

More specifically, the present method and system are defined in the independent claims.

According to one aspect, the method for determining particle size information of particles contained in a sample comprises:
illuminating the particles with at least three light sources placed on different locations around the sample, preferably in the circumference of a circle at a distance from the sample are to be imaged, simultaneously with the at least three light sources each operating at a different wavelength channel,
detecting light reflected from the particles using a detector capable of spatial resolution simultaneously on said wavelength channels separately, and
processing the output of the detector so as to determine the particle size information.

According to one embodiment, the output of the detector forms an image in which some of the particles are in focus and some are out-of-focus, because of suitable detection optics. The particles that are in focus are detected by image processing.

According to one embodiment, the light sources are placed around the sample at equal angles α, as in FIG. 1. The angle can be 0-90°, preferably 10-45°. The oblique angle helps to distinguish the particles from each other during the analysis phase and to obtain more accurate size determination results. The light sources may be places symmetrically around the sample, but they need not be.

According to one embodiment, the sample is a fluid, preferably a powder, liquid or gas, which contains the particles to be measured. According to one embodiment, the sample is a non-fluid powder surface containing particles. The particles may be pharmaceutical particles. The fluid may be in constant motion. Thus, it may form a stream, which allows for continuous on-line monitoring of processes.

According to one embodiment, there is provided a transparent window between the detector/light sources and the sample. The transparent window may comprise a glass plate. According to one embodiment, there is provided at least two superimposed glass plates, by which arrangement a wider angle of illumination can be achieved should the window on the sample side be small or have a light-blocking collar.

According to one embodiment, the focal plane of the camera is at the surface of the transparent window. This is a preferred option at least when the sample is opaque, such as powders typically are. Thus, the measurement is directed to the topmost layer or layers of the sample.

According to another embodiment, the focal plane of the camera is in the sample at a distance from the transparent window. The depth of field of the image obtained and subsequent image processing can used to take pick the particles which are in focus for particle size determination. Said processing may comprise
determining particles that are in focus,
fitting an ellipse to each particle determined to be in focus, and
determining the size, and optionally shape, of the particles using ellipse parameters of the ellipses fitted.

Thus, particles not in focus based on predefined criteria are preferably not used in the size determination. The depth of field of the imaging optics forms a constant volume. This information can be used for determining the density of the particles of interest in the sample.

Determination of the particles that are in focus helps to avoid size determination problems associated with at least some known optical size measurement methods.

According to one embodiment, the illumination is realized as a short and high energy light pulse, for eliminating particle movement. In this case, the detector can be a camera whose exposure time is adjusted to be longer than the illumination period of the light sources.

This helps to perform the measurement for fast-moving particles as the required temporal capabilities of light sources are generally better than those of detectors. Preferably, the light sources are capable of providing a light pulse having a duration of less than 5 μs.

The term particle is herein used to describe solid particles, droplets, bubbles or other visually identifiable entities. The sample may be essentially formed by the particles themselves or it may contain a fluid or solid medium as a carrier of the particles.

Considerable advantages are obtained by means of the invention and its embodiments. First, no sample preparation, such as leveling, is needed. Second, there is no need to have a constant distance between the measurement head and the particles. Third, the size estimation is based on estimating the actual geometrical size of the particles rather than indirect estimation like previous methods. The movement of the particles is compensated with a very short and high energy light pulse, which enables capturing images without motion blur. Fourth, the disclosed method also allows one to measure through a small diameter glass plate where the boundary would block the illumination with traditional geometry. Moreover, the illumination geometry can be such that particles can be measured even behind a thick glass.

Next, embodiments of the invention are described in more detail with references to the attached drawings.

### BRIEF DESCRIPTION OF THE DRAWINGS

FIG. 1 shows a measurement setup according to one embodiment of the invention.

FIG. 2 illustrates the principle of measuring particles behind a glass plate.

FIG. 3 illustrates a method of measuring through a small glass plate where for example the collar of the glass would block the illumination with the geometry presented in FIG. 2.

FIG. 4 illustrates the use of short light pulses to capture moving particles.

FIG. 5 explains the image processing procedure for estimating the particle size from images captured with the present method.

FIG. 6 illustrates the situation where some particles are in focus and some are not.

### DETAILED DESCRIPTION OF EMBODIMENTS

The present invention can be used for imaging particle-containing fluids, including fluid powders, or non-fluid particulate matter. In addition to powdery form, the fluid may be in gaseous or liquid form. The fluid is typically provided in the form of a stream having a velocity. Thus, the particles contained in the fluid may be moving during the measurement.

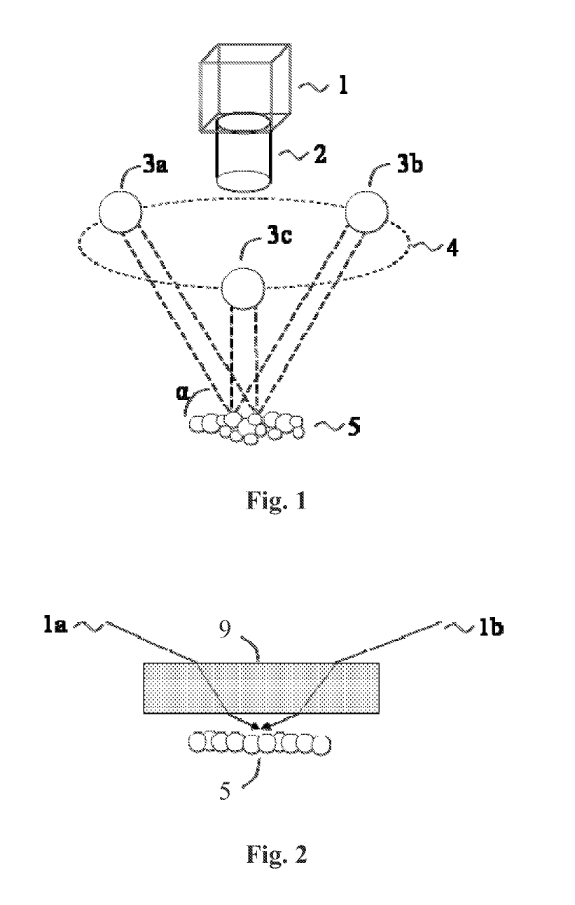

FIG. 1 illustrates the measurement setup. A camera 1 equipped with suitable imaging optics 2 takes a picture of the sample 5. The system comprises at least three light sources, i.e., illumination units 3a-3c with different wavelengths. The illumination units are distributed around the camera, and each illuminate the area to be imaged, with some know angle α. The angle α may be 0-90°, typically 10-45°. Preferably, the illumination units are evenly distributed at a circle concentric with the camera 1. For being able to measure moving particles, the illumination unit must be fired essentially simultaneously.

The camera can be, for example, a CCD camera or other digital imaging unit capable of both spatial and spectral resolution.

The illumination units may comprise any units known per se. Preferably, they are capable of providing pulsed light, which may be achieved using an inherent property of the light source (flash-type lamps) or a separate light chopper (continuous-type lamps). Similarly, the wavelength channel of each of the light sources can be inherent to the light source itself (e.g. LED lamps or other narrow-band light sources) or achieved using filters provided in the light paths (broadband light sources). The three or more light sources may also distribute light originating from a single parent light source, for example, using optical waveguides, such as optical fibers, or reflecting elements, such as prisms or mirrors.

The wavelength bands of the light sources naturally should overlap, at least partly, with the detection channels of the detector. According to one embodiment, the wavelength bands and detection channels correspond to red, green and blue wavelengths.

In addition to the parts listed above, the system preferably comprises a control unit (not shown) for automatic control of the exposure time of the camera and for illumination of the sample by the illumination units. In addition, there may be analysis means (not shown), such as a computer, for image capture, optionally also image storage, and signal processing.

FIG. 2 illustrates measuring a sample 5 behind a glass plate 9. The illumination beams 1a-1b refraction in they pass from air to glass and vice versa. The illumination angles remain the same as in FIG. 1.

The present method does not necessitate the presence of a glass plate or any other transparent window. It can be applied also directly for free, stacked, floating, dropping or sprayed particles, for example, without a window separating the illumination units/imaging optics and the sample. The imaging optics define the zone of interest, which is at a constant distance from the detector with predefined optical arrangement.

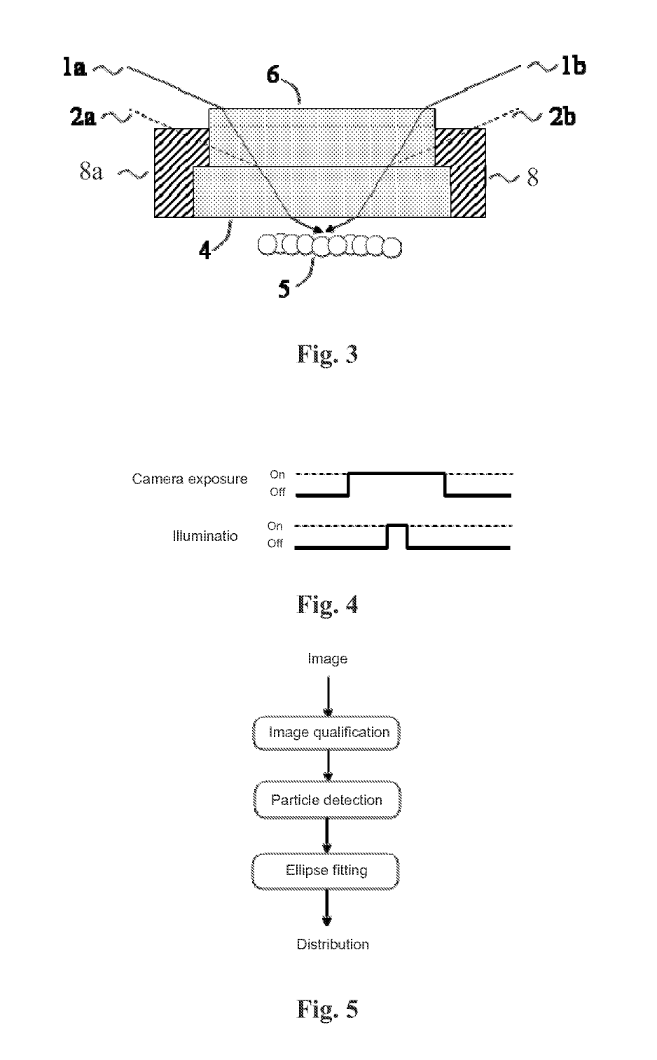

FIG. 3 illustrates the method of measuring through a small glass plate where for example the collar of the glass would block the illumination with the geometry presented in FIG. 2. The collar 3a, 3b holds the glass 4, while blocking the illumination rays 2a, 2b. With an extra optical member 6, such as a glass plate, arranged on top of the lower glass plate 4, the rays 1a, 1b illuminate the particles 5 without blockage while the illumination angle to the sample remains unchanged. The optical member 6 can also be curved on the other or both sides. The curved surface can be used to modify incident angle of the light beam entering the sample. The extra member 6 may act as a lens allowing for guiding of the illumination light to the sample in such circumstances where the measurement window is surrounded by a collar extending above the level of the window surface, i.e. located deep.

FIG. 4 illustrates the use of short light pulses to capture moving particles. Instead of using constant light and short illumination time, a short light pulse is produced while the camera is exposure is on for a period longer than the duration of the light pulse. This enables very short illumination without using special high speed cameras. This embodiment is particularly suitable for fast-moving sample streams.

FIG. 5 explains the image processing procedure for estimating the particle size from images captured with the described method. First step is to determine the particles that are in focus distance. This can be achieved e.g. using intensity and gradient information. This procedure defines the area and volume in which the measurement is done. This volume is constant and the particles included this volume are used in the measurement. In the seconds step a blob analysis is made for detecting the particles. In third step an ellipse is fitted to each detected particle. Ellipse parameters provide both size and shape information of the particles.

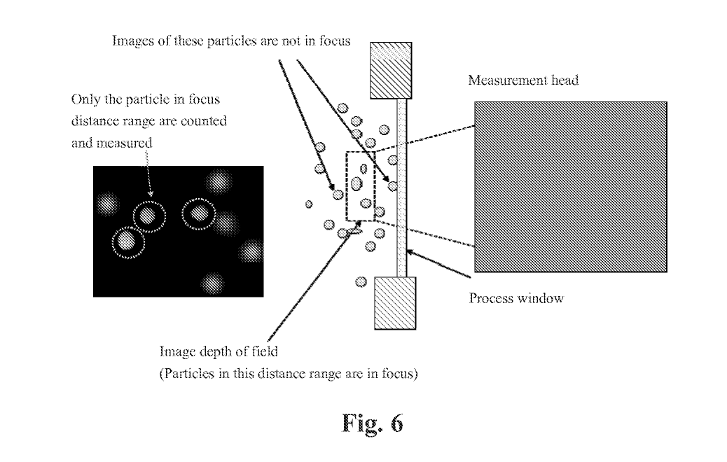

FIG. 6 illustrates the situation where some particles are in focus and some are not. The disclosed method can estimate what particles are in the right distance for analysis. As an example, the particle marked with dotted circles would be accepted for the size analysis.

Using different wavelengths for different illumination angles enables capturing the different illumination geometries with a single color image. Using this, the color values encode the surface gradient information, which be transformed into 3-D information following the well known principle of photometric stereo (“Photometric Method for Determining Surface Orientation from Multiple Images.” Woodman, Robert J. Optical Engineering, Vol. 19, No. 1, 1980, pp. 139-144). The present invention takes advantage of the 3-D information in the particle detection stage of the image processing and particle size estimation. Using only gray level intensity information, occluded particles can lead to false detections, where e.g. a group of particles is determined as one, if there is not enough shadow or gradient to provide information for separating particles form each other. E.g. in such cases the 3-D information gives additional information and leads to more precise detections.

1. A method for determining particle size information of particles contained in a sample, the method comprising:
illuminating the particles with at least three light sources placed on different locations,
detecting light reflected from the particles using a detector capable of spatial resolution, and
processing the output of the detector so as to determine the particle size information, wherein
the particles are illuminated simultaneously with the at least three light sources each operating at a different wavelength
said wavelength channels are simultaneously detected at the detector.

2. The method according to claim 1, wherein the light sources are placed symmetrically around the sample at equal angles with respect to the direction defined by the sample and the detector.

3. The method according to claim 1, wherein the sample is a fluid.

4. The method according to claim 1, wherein the particles are moving during the measurement.

5. The method according to claim 1, wherein there is not provided a particle movement-restricting window between the detector and light sources, and the sample.

6. The method according to claim 1, wherein there is provided a transparent window between the detector and light sources, and the sample.

7. The method according to claim 6, wherein there is provided an additional transparent member on the transparent window.

8. The method according to claim 6, wherein the focal plane of the camera is in the sample at a distance from the transparent window.

9. The method according to claim 1, wherein the detector is a camera whose exposure time is adjusted to be longer than the illumination period of the light sources.

10. The method according to claim 1, wherein said processing comprises
determining the particles that are in focus,
fitting an ellipse to each particle determined to be in focus, and
determining the size, and optionally shape, of the particles using ellipse parameters of the ellipses fitted.

11. The method according to claim 1, wherein the particles are pharmaceutical particles.

12. The method according to claim 1, wherein the light sources are capable of providing a light pulse having a duration of less than 5 μs.

13. The method according to claim 1, comprising forming an image of the sample in which some of the particles are in focus and some of the particles are out of focus and detecting from the image particles that are in focus.

14. The method according to claim 1, wherein three-dimensional information of the sample, obtained utilizing the different wavelengths, is used for particle size estimation.

15. The method according to claim 1, wherein the density of particles in the sample is determined based on information on the volume of the depth of field of the image formed at the detector.

16. A system for determining particle size information of particles contained in a sample, the system comprising:
a sample zone for said sample,
at least three light sources placed on different locations for illuminating the particles,
means for spatially detecting light reflected from the particles for forming an image of the particles,
means for processing the image of particles for determining the particle size information, wherein
said light sources are adapted to operate simultaneously and at different wavelength channels,
said means for detecting are capable of spatially measuring all said wavelength channels simultaneously.

17. (canceled)
